(19) United States
(12) Patent Application Publication
(10) Pub. No.: US 2026/0095980 A1
(43) Pub. Date: Apr. 2, 2026

(54) GRADIENT HEATING DEVICE AND METHOD FOR TITANIUM/AUSTENITIC STAINLESS STEEL COMPOSITE PLATE

(71) Applicant: Taiyuan University of Technology, Taiyuan City (CN)

(72) Inventors: Zhongkai REN, Taiyuan City (CN); Haoyu REN, Taiyuan City (CN); Xiongwei GUO, Taiyuan City (CN); Jinyu ZHAO, Taiyuan City (CN); Qi ZHANG, Taiyuan City (CN); Tao WANG, Taiyuan City (CN)

(21) Appl. No.: 19/336,792

(22) Filed: Sep. 23, 2025

(30) Foreign Application Priority Data
Sep. 28, 2024 (CN) 202411364031.5

(51) Int. Cl. H05B 6/06; H05B 6/10

(52) U.S. Cl. CPC H05B 6/06; H05B 6/101

(57) ABSTRACT

A gradient heating device and a method for a titanium/austenitic stainless steel composite plate are provided. The device includes a first support frame equipped with a heating box; a second support frame arranged inside the heating box; a pair of clamps configured to clamp the titanium steel composite plate, with a positive electrode interface and a negative electrode interface respectively provided on the pair of clamps; a pulse power supply connected to the positive electrode interface and the negative electrode interface; a pressing plate slidably arranged on the second support frame and configured to abut against a steel side of the titanium steel composite plate; a magnetic field generator arranged on the second support frame; and a cooling plate arranged on the first support frame and configured to abut against a titanium side of the titanium steel composite plate, with cooling fluid flowing inside the cooling plate.

### CROSS-REFERENCE TO RELATED APPLICATIONS

This application claims priority to Chinese Patent Application No. 202411364031.5, filed on Sep. 28, 2024, the contents of which are hereby incorporated by reference.

### TECHNICAL FIELD

The present disclosure relates to the technical field of metal composite material processing, and in particular to a gradient heating device and a method for a titanium/austenitic stainless steel composite plate.

### BACKGROUND

Combining titanium with other metal materials to prepare composite materials may leverage the unique advantages of titanium while reducing costs, representing a significant trend in the rational utilization of titanium. Stainless steel is a reliable, high-strength, low-cost structural material with excellent corrosion resistance, low-temperature properties, machinability, and weldability. However, in environments such as marine and oil wells applications involving high temperature, high humidity, and chloride ions, elevated temperatures and salt spray may casily damage the passive film on stainless steel surfaces, leading to pitting and crevice corrosion, which reduces its service life. Titanium/austenitic stainless steel composite plates combine the performance advantages of both materials while lowering material costs, gradually becoming substitutes for pure titanium and offering promising development prospects.

Annealing effectively mitigates work hardening and residual stress in metal materials. Conventional annealing methods typically involve heating plates to a single temperature in a furnace before annealing. For austenitic stainless steel, solution heat treatment (with a heating temperature range generally between 950 degrees Celsius (° C.) and 1050° C.) aims to heat the alloy to a high-temperature single-phase zone, maintain it for a certain time to fully dissolve intermediate phases into the solid solution, and then rapidly cool it to improve corrosion resistance and obtain a carbon-supersaturated austenitic structure. This process is crucial for enhancing the mechanical properties and corrosion resistance of austenitic stainless steel. Stress relief annealing for titanium (typically between 450° C. and 650° C.) is primarily used to eliminate internal stresses generated during the processing of titanium and titanium alloys, preventing cracking or failure during use due to residual stresses. However, the annealing temperatures for titanium and stainless steel differ. Heating a titanium/austenitic stainless steel composite plate to a single annealing temperature significantly impacts the performance of composite plate. Annealing the titanium/austenitic stainless steel composite plate at titanium annealing temperature results in insufficient heating temperature on the stainless steel side, and in the low-temperature annealing range, the grain size and hardness of the stainless steel change only marginally. This insufficient heating at the composite interface leads to inadequate reduction in hardness and insufficient strength enhancement on the steel side, ultimately deteriorating the interfacial bonding performance. The annealing temperature for stainless steel is around 900° C., while titanium's phase transition point is approximately 882° C. Heating titanium at the temperature used for austenitic stainless steel causes phase transformation in titanium, changing titanium from a hexagonal close-packed structure to a body-centered cubic structure, while simultaneously leading to excessive heating at the composite interface. When the annealing temperature exceeds 600° C., titanium grains grow noticeably, and hardness decreases significantly. Excessive annealing temperature at the bonding interface weakens intergranular connections and promotes the formation of brittle and hard compounds at the bonding interface, deteriorating interfacial bonding performance. Therefore, it is necessary to achieve differential heating (or gradient heating) on the austenitic stainless steel side, the titanium side, and the bonding interface side. Hence, there is an urgent need for a gradient heating device and a method for titanium/austenitic stainless steel composite plates.

### SUMMARY

The objective of the present disclosure is to provide a gradient heating device and a method for a titanium/austenitic stainless steel composite plate, aiming to address or improve at least one of the aforementioned technical issues.

To achieve this objective, the present disclosure provides the following solutions: a gradient heating device for a titanium/austenitic stainless steel composite plate, including:
a first support frame, where a heating box is arranged on the first support frame;
a second support frame arranged inside the heating box;
a pair of clamps relatively slidably arranged inside the heating box, where the pair of clamps are configured to clamp a titanium steel composite plate, and the pair of clamps are respectively provided with a positive electrode interface and a negative electrode interface;
a pulse power supply arranged on the heating box, where the pulse power supply is connected to the positive electrode interface and the negative electrode interface;
a pressing plate slidably arranged on the second support frame, where the pressing plate is configured to abut against a steel side of the titanium steel composite plate;
a magnetic field generator arranged on the second support frame, where the magnetic field generator is connected to the pulse power supply; and
a cooling plate arranged on the first support frame, where the cooling plate is configured to abut against a titanium side of the titanium steel composite plate, a cooling fluid flows inside the cooling plate, and the cooling plate is in communication with a cooling fluid circulation and condensation system.

In some embodiments, the device includes a gas source, the gas source is in communication with an air vent via a pipeline, and the air vent is in communication with an inner cavity of the heating box.

In some embodiments, the device includes a first thermometer, the first thermometer is arranged inside the heating box, and the first thermometer is configured to measure a temperature of the titanium side of the titanium steel composite plate.

In some embodiments, the device includes a second thermometer, the second thermometer is arranged inside the heating box, and the second thermometer is configured to measure a temperature of the steel side of the titanium steel composite plate.

In some embodiments, the second support frame is provided with a pair of first slide rails, a sliding frame is slidably connected between the pair of first slide rails, the sliding frame is provided with a first motor for driving the sliding frame to slide along the pair of first slide rails, and the sliding frame is connected to the pressing plate via a connecting frame.

In some embodiments, the second support frame is provided with a pair of limiters, and the pair of limiters are configured to limit a sliding range of the sliding frame.

In some embodiments, the second support frame is provided with a pair of second slide rails, the pair of clamps are slidably connected to the pair of second slide rails, and each clamp is provided with a second motor for driving the clamp to slide along the pair of second slide rails.

In some embodiments, the cooling plate includes a plate body provided with a flow channel, a sealing ring arranged on the plate body, and a plate cover connected to the plate body, the flow channel inside the plate body is in communication with the cooling fluid circulation and condensation system.

In some embodiments, the cooling fluid circulation and condensation system includes a compressor, an outlet of the compressor is sequentially in communication with a first condenser, a second condenser, a pressure compensator, and a capillary tube via pipelines, the capillary tube is in communication with an inlet of the flow channel via the pipeline, and an outlet of the flow channel is in communication with an inlet of the compressor via the pipeline.

The present disclosure further provides a gradient heating method for the titanium/austenitic stainless steel composite plate, which includes the following steps:
clamping and fixing the titanium steel composite plate by the pair of clamps, abutting the steel side of the titanium steel composite plate against the pressing plate, and abutting the titanium side of the titanium steel composite plate against the cooling plate;
transmitting a current generated by the pulse power supply to the pair of clamps via the positive electrode interface and the negative electrode interface, so as to heat the titanium steel composite plate by the pair of clamps;
adjusting an internal current distribution of the titanium steel composite plate by the magnetic field generator, so as to enable the current to concentrate away from a bonding interface between the steel side and the titanium side of the titanium steel composite plate; and
circulating a condensing agent in the cooling plate via the cooling fluid circulation and condensation system, so as to cool the titanium side of the titanium steel composite plate by the cooling plate.

The present disclosure discloses the following technical effects: by clamping the titanium steel composite plate through the pair of clamps and abutting the steel side against the pressing plate and the titanium side against the cooling plate, the position of the titanium steel composite plate is fixed. The pulse power supply transmits electric current to the pair of clamps via the positive electrode interface and the negative electrode interface, so that the pair of clamps heat the titanium steel composite plate. The magnetic field generator adjusts the magnetic field intensity as well as the direction and the magnitude of the current, causing the current to concentrate away from the bonding interface between the steel side and the titanium side of the titanium steel composite plate. As a result, the temperatures on both the steel side and the titanium side of the titanium steel composite plate are maintained at elevated levels. Meanwhile, the cooling fluid circulation and condensation system reduces the temperature of the titanium side of the titanium steel composite plate through the cooling plate to reach a preset temperature, while achieving precise control of the bonding interface temperature. This enables gradient current heating of the titanium steel composite plate, significantly reducing the formation of brittle and hard compounds at the bonding interface. Consequently, the bonding performance, oxidation resistance, and corrosion resistance are improved, the element diffusion capability near the interface is enhanced, and the high-strength bonding of the titanium steel composite plate is achieved.

### BRIEF DESCRIPTION OF THE DRAWINGS

The drawings, which constitute a part of this disclosure, are used to provide a further understanding of this disclosure. The illustrative embodiment of this disclosure and its description are used to explain this disclosure, and do not constitute an improper limitation of this disclosure.

In the drawings:

FIG. 1 is a schematic diagram of an overall structure of the present disclosure.

FIG. 2 is a schematic diagram of an internal structure of a heating box of the present disclosure.

FIG. 3 is a partial schematic diagram of a second support frame of the present disclosure.

FIG. 4 is a schematic diagram of a cooling plate of the present disclosure.

FIG. 5 is a schematic diagram of an internal structure of the cooling plate of the present disclosure.

FIG. 6 is a flowchart of a gradient heating method of the present disclosure.

### DETAILED DESCRIPTION OF THE EMBODIMENT

In the following, the technical solution in the embodiment of the disclosure will be clearly and completely described with reference to the attached drawings. Apparently, the described embodiment is only a part of the embodiment of the disclosure, but not the whole embodiment. Based on the embodiment in the present disclosure, all other embodiments obtained by ordinary technicians in the field without creative labor belong to the scope of protection of the present disclosure.

In order to make the above objects, features and advantages of the present disclosure more obvious and easy to understand, the present disclosure will be further described in detail with the attached drawings and the specific embodiment.

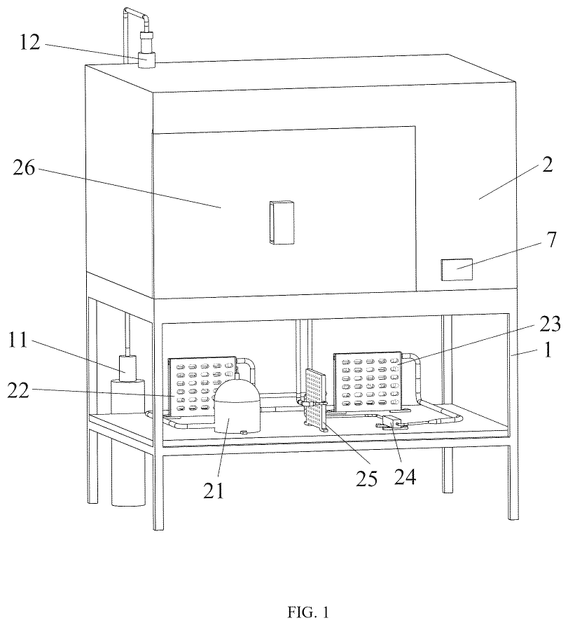

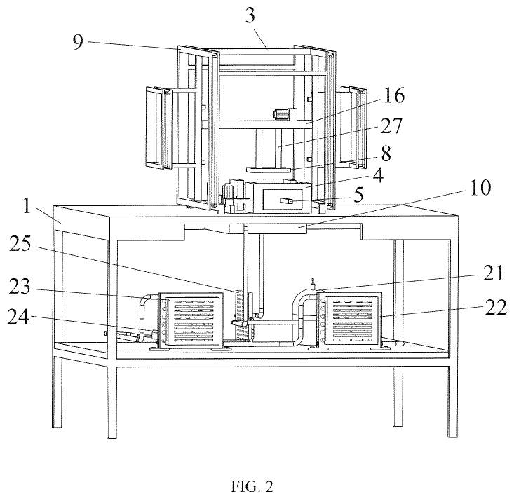

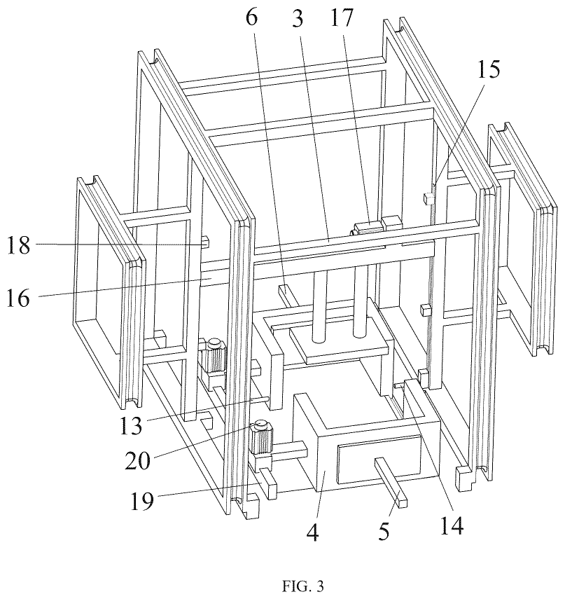

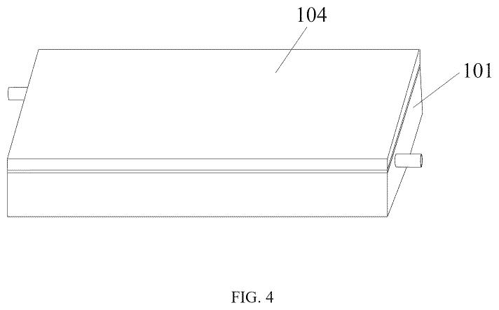

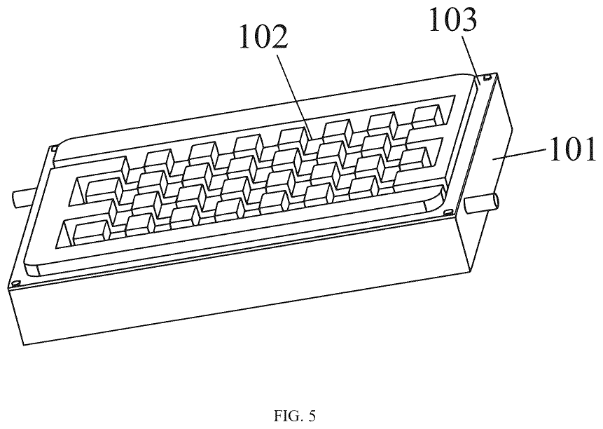

Referring to FIG. 1, FIG. 2, FIG. 3, FIG. 4 and FIG. 5, the present disclosure provides a gradient heating device for a titanium/austenitic stainless steel composite plate, including a first support frame 1, a second support frame 3, a pair of clamps 4, a pulse power supply 7, a pressing plate 8, a magnetic field generator 9, and a cooling plate 10.

A heating box 2 is arranged on the first support frame 1.

The second support frame 3 is arranged inside the heating box 2.

The pair of clamps 4 are arranged inside the heating box 2 and slidable with respect to one another, the pair of clamps 4 are configured to clamp a titanium steel composite plate, and the pair of clamps 4 are respectively provided with a positive electrode interface 5 and a negative electrode interface 6.

The pulse power supply 7 is arranged on the heating box 2, and the pulse power supply 7 is connected to the positive electrode interface 5 and the negative electrode interface 6.

The pressing plate 8 is slidably arranged on the second support frame 3, and the pressing plate 8 is configured to abut against a steel side of the titanium steel composite plate.

The magnetic field generator 9 is arranged on the second support frame 3, and the magnetic field generator 9 is connected to the pulse power supply 7.

The cooling plate 10 is arranged on the first support frame 1, the cooling plate 10 is configured to abut against a titanium side of the titanium steel composite plate, a cooling fluid flows inside the cooling plate 10, and the cooling plate 10 is in communication with a cooling fluid circulation and condensation system.

By clamping the titanium steel composite plate with the pair of clamps 4 and abutting the steel side against the pressing plate 8 and the titanium side against the cooling plate 10, the position of the titanium steel composite plate is fixed. The pulse power supply 7 transmits electric current to the pair of clamps 4 via the positive electrode interface 5 and the negative electrode interface 6, so that the pair of clamps 4 heat the titanium steel composite plate. The magnetic field generator 9 adjusts the magnetic field intensity as well as the direction and the magnitude of the current, causing the current to concentrate away from the bonding interface between the steel side and the titanium side of the titanium steel composite plate. As a result, the temperatures on both the steel side and the titanium side of the titanium steel composite plate are maintained at elevated levels. Meanwhile, the cooling fluid circulation and condensation system reduces the temperature of the titanium side of the titanium steel composite plate through the cooling plate 10 to reach a preset temperature, while achieving precise control of the bonding interface temperature. This enables gradient current heating of the titanium steel composite plate, significantly reducing the formation of brittle and hard compounds at the bonding interface. Consequently, the bonding performance, oxidation resistance, and corrosion resistance are improved, the element diffusion capability near the interface is enhanced, and the high-strength bonding of the titanium steel composite plate is achieved.

In this embodiment, a movable protective door 26 is arranged on the side wall of the heating box 2.

In this embodiment, the magnetic field generator 9 is a rectangular Helmholtz coil magnetic field generator.

In this embodiment, the device further includes a gas source 11, the gas source 11 is in communication with an air vent 12 via the pipeline, and the air vent 12 is in communication with an inner cavity of the heating box 2.

Inert gas is continuously introduced into the heating box 2 via the gas source 11 and the air vent 12 to prevent oxidation of the composite plate during heating.

In this embodiment, the device further includes a first thermometer 13, the first thermometer 13 is arranged inside the heating box 2, and the first thermometer 13 is configured to measure a temperature of the titanium side of the titanium steel composite plate.

In this embodiment, the device further includes a second thermometer 14, the second thermometer 14 is arranged inside the heating box 2, and the second thermometer 14 is configured to measure a temperature of the steel side of the titanium steel composite plate.

The first thermometer 13 and the second thermometer 14 obtain the temperature information and feed it back to the controller. The controller controls the pulse power supply 7 to adjust the magnetic field intensity of the magnetic field generator 9 and the current strength of the clamps 4, so as to control the heating temperature of the steel side and the titanium side of the titanium steel composite plate. Furthermore, the controller controls the compensation pressure of the pressure compensator 24, thereby adjusting the cooling temperature of the titanium side of the titanium steel composite plate.

In this embodiment, the first thermometer 13 and the second thermometer 14 are infrared thermometers.

In this embodiment, the second support frame 3 is provided with a pair of first slide rails 15, a sliding frame 16 is slidably connected between the pair of first slide rails 15, the sliding frame 16 is provided with a first motor 17 for driving the sliding frame 16 to slide along the pair of first slide rails 15, and the sliding frame 16 is connected to the pressing plate 8 via a connecting frame 27.

The first motor 17 is configured to drive the sliding frame 16 to slide along the first slide rails 15, thereby moving the pressing plate 8 via the connecting frame, thus achieving the pressing action of the pressing plate 8 and ensuring tight contact between the titanium steel composite plate and the cooling plate 10.

In this embodiment, the second support frame 3 is provided with a pair of limiters 18, and the pair of limiters 18 are configured to limit a sliding range of the sliding frame 16.

The pair of limiters 18 provide safety protection for the sliding frame 16 during pressing.

In this embodiment, the second support frame 3 is provided with a pair of second slide rails 19, the pair of clamps 4 are slidably connected to the pair of second slide rails 19, and each clamp 4 is provided with a second motor 20 for driving the clamp 4 to slide along the pair of second slide rails 19.

The second motor 20 is configured to drive the clamps 4 to slide along the second slide rails 19, enabling the pair of clamps 4 to clamp the titanium steel composite plate and accommodate titanium steel composite plates of different sizes for heating.

In this embodiment, the clamps 4 are made of copper.

In this embodiment, the cooling plate 10 includes a plate body 101 provided with a flow channel 102, a sealing ring 103 arranged on the plate body 101, and a plate cover 104 connected to the plate body 101, the flow channel 102 inside the plate body 101 is in communication with the cooling fluid circulation and condensation system.

In this embodiment, the cooling fluid circulation and condensation system includes a compressor 21, an outlet of the compressor 21 is sequentially in communication with a first condenser 22, a second condenser 23, the pressure compensator 24, and a capillary tube 25 via pipelines, the capillary tube 25 is in communication with an inlet of the flow channel 102 via the pipeline, and an outlet of the flow channel 102 is in communication with an inlet of the compressor 21 via the pipeline.

The compressor 21 circulates a condensing agent, which is cooled by the first condenser 22 and the second condenser 23, throttled and depressurized by the capillary tube 25, and pressure-compensated by the pressure compensator 24, thereby flowing through the flow channel 102 to cool the titanium side of the titanium steel composite plate via the cooling plate 10, and achieve the preset temperature of the titanium side.

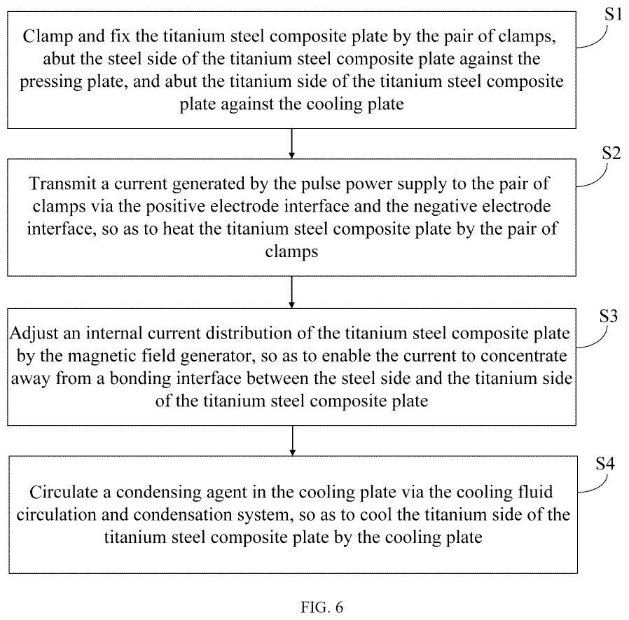

As shown in FIG. 6, a gradient heating method for a titanium/austenitic stainless steel composite plate is provided, which includes the following steps.

The second motor 20 drives the clamps 4 to slide along the second slide rails 19, the titanium steel composite plate is clamped and fixed by the pair of clamps 4, the first motor 17 drives the sliding frame 16 to slide along the first slide rails 15, the pressing plate 8 is pressed tightly against the titanium steel composite plate to ensure the titanium side abuts tightly against the cooling plate 10, thereby abutting the steel side against the pressing plate 8 and the titanium side against the cooling plate 10.

The electric current generated by the pulse power supply 7 is transmitted to the pair of clamps 4 via the positive electrode interface 5 and the negative electrode interface 6, thereby heating the titanium steel composite plate with the pair of clamps 4.

By adjusting the current of the pulse power supply 7, the magnetic field intensity of the magnetic field generator 9 is adjusted, thereby adjusting the internal current distribution of the titanium steel composite plate by the magnetic field generator 9, causing the current to concentrate away from the bonding interface between the steel side and the titanium side, and increasing current density and temperature of the steel side and the titanium side, so as to reach the preset temperature of the steel side.

The condensing agent flows in the cooling plate 10 via the cooling fluid circulation and condensation system, thereby cooling the titanium side of the titanium steel composite plate with the cooling plate 10.

After the heating and cooling of the titanium steel composite plate in the heating box are completed, the movable protective door 26 is opened, the pressing plate 8 is lifted, the clamps 4 are moved in the opposite direction, the pulse power supply 7 is turned off, and the titanium steel composite plate is removed.

In the description of the present disclosure, it should be understood that terms such as “longitudinal,” “transverse,” “upper,” “lower,” “front,” “rear,” “left,” “right,” “vertical,” “horizontal,” “top,” “bottom,” “inner,” and “outer” indicate orientations or positional relationships based on the accompanying drawings, and are used only for ease of description, not to imply that the device or element must have a specific orientation or be constructed or operated in a specific orientation. Therefore, these terms should not be construed as limiting the disclosure.

The above-described embodiment is only illustrative of the optional embodiment of the present disclosure, and the scope of the present disclosure is not limited thereto. Variations and improvements made by those skilled in the art without departing from the spirit of the present disclosure shall fall within the protection scope defined by the claims of the present disclosure.

What is claimed is:

1. A gradient heating device for a titanium/austenitic stainless steel composite plate, comprising:
a first support frame, wherein a heating box is arranged on the first support frame;
a second support frame arranged inside the heating box;
a pair of clamps relatively slidably arranged inside the heating box, wherein the pair of clamps are configured to clamp a titanium steel composite plate, and the pair of clamps are respectively provided with a positive electrode interface and a negative electrode interface;
a pulse power supply arranged on the heating box, wherein the pulse power supply is connected to the positive electrode interface and the negative electrode interface;
a pressing plate slidably arranged on the second support frame, wherein the pressing plate is configured to abut against a steel side of the titanium steel composite plate;
a magnetic field generator arranged on the second support frame, wherein the magnetic field generator is connected to the pulse power supply; and
a cooling plate arranged on the first support frame, wherein the cooling plate is configured to abut against a titanium side of the titanium steel composite plate, a cooling fluid flows inside the cooling plate, and the cooling plate is in communication with a cooling fluid circulation and condensation system.

2. The gradient heating device for the titanium/austenitic stainless steel composite plate according to claim 1, further comprising a gas source, wherein the gas source is in communication with an air vent via a pipeline, and the air vent is in communication with an inner cavity of the heating box.

3. The gradient heating device for the titanium/austenitic stainless steel composite plate according to claim 1, further comprising a first thermometer arranged inside the heating box, wherein the first thermometer is configured to measure a temperature of the titanium side of the titanium steel composite plate.

4. The gradient heating device for the titanium/austenitic stainless steel composite plate according to claim 1, further comprising a second thermometer arranged inside the heating box, wherein the second thermometer is configured to measure a temperature of the steel side of the titanium steel composite plate.

5. The gradient heating device for the titanium/austenitic stainless steel composite plate according to claim 1, wherein the second support frame is provided with a pair of first slide rails, a sliding frame is slidably connected between the pair of first slide rails, the sliding frame is provided with a first motor for driving the sliding frame to slide along the pair of first slide rails, and the sliding frame is connected to the pressing plate via a connecting frame.

6. The gradient heating device for the titanium/austenitic stainless steel composite plate according to claim 5, wherein the second support frame is provided with a pair of limiters, and the pair of limiters are configured to limit a sliding range of the sliding frame.

7. The gradient heating device for the titanium/austenitic stainless steel composite plate according to claim 1, wherein the second support frame is provided with a pair of second slide rails, the pair of clamps are slidably connected to the pair of second slide rails, and each clamp of the pair of clamps is provided with a second motor for driving the clamp to slide along the pair of second slide rails.

8. The gradient heating device for the titanium/austenitic stainless steel composite plate according to claim 1, wherein the cooling plate comprises a plate body provided with a flow channel, a sealing ring arranged on the plate body, and a plate cover connected to the plate body, and wherein the flow channel inside the plate body is in communication with the cooling fluid circulation and condensation system.

9. The gradient heating device for the titanium/austenitic stainless steel composite plate according to claim 8, wherein the cooling fluid circulation and condensation system comprises a compressor, an outlet of the compressor is sequentially in communication with a first condenser, a second condenser, a pressure compensator, and a capillary tube via pipelines, wherein the capillary tube is in communication with an inlet of the flow channel via a pipeline, and an outlet of the flow channel is in communication with an inlet of the compressor via a second pipeline.

10. A gradient heating method, adopting the gradient heating device for the titanium/austenitic stainless steel composite plate according to claim 1, comprising following steps:
clamping and fixing the titanium steel composite plate by the pair of clamps, abutting the steel side of the titanium steel composite plate against the pressing plate, and abutting the titanium side of the titanium steel composite plate against the cooling plate;
transmitting a current generated by the pulse power supply to the pair of clamps via the positive electrode interface and the negative electrode interface, so as to heat the titanium steel composite plate by the pair of clamps;
adjusting an internal current distribution of the titanium steel composite plate by the magnetic field generator, so as to enable the current to concentrate away from a bonding interface between the steel side and the titanium side of the titanium steel composite plate; and
circulating a condensing agent in the cooling plate via the cooling fluid circulation and condensation system, so as to cool the titanium side of the titanium steel composite plate by the cooling plate.
